(19) United States
(12) Patent Application Publication
(10) Pub. No.: US 2010/0002689 A1
(43) Pub. Date: Jan. 7, 2010

(54) VOICE OVER IP ADAPTER

(75) Inventors: Malcom Strandberg, Cambridge, MA (US); Eyal BenChanoch, Miami, FL (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software, Inc., Chelmsford, MA (US)

(21) Appl. No.: 12/556,917

(22) Filed: Sep. 10, 2009

Related U.S. Application Data
(62) Division of application No. 11/430,502, filed on May 9, 2006.

(51) Int. Cl. H04L 12/66

(52) U.S. Cl. 370/352

(57) ABSTRACT

A headset and adapter that converts between Voice Over Internet Protocol (VOIP) network of a contact center and an audio signal received and generated by an agent of the contact center wearing the headset is disclosed. A VoIP terminal receives and transmits VoIP instructions and application program interface instructions over a contact center network. An audio terminal receives an audio signal from a microphone and transmits an audio signal to a speaker. A processor of the adapter converts a received VoIP signal to the transmitted audio signal and converts the received audio signal to a transmitted VoIP instruction.

### RELATED APPLICATION

This application is a divisional of U.S. patent application Ser. No. 11/430,502 filed on May 9, 2005 which is incorporated fully herein by reference.

### TECHNICAL FIELD

The present invention relates to Voice Over Internet Protocol (VoIP), and more specifically relates to an adapter for VoIP devices.

### BACKGROUND INFORMATION

Contact centers place and receive telephone calls, emails, textual chats, and other methods of communication (hereinafter collectively referred to as “communications”) to customers. Agents at the contact center handle the communications with the customer and guide the customer in obtaining information or providing the requested information. Customers may include current customers, previous customers, and individuals with information or with a desire to obtain additional information.

A growing number of businesses have begun using contact centers to handle interactions with customers. Companies typically use contact center services, for example, to manage outbound and inbound communication campaigns to potential customers for telemarketing or to existing customers for collections information or customer follow-up. At any particular time a contact center may be handling multiple campaigns for multiple businesses. Agents are expected to rapidly supply information for various campaigns of the contact center. To aid the agents, additional contact center software and hardware may assist the agent in placing and receiving calls, accessing information during the call session and logging information. The software may utilize an application program interface, which may control the dialing and connection of the phone. The agent or contact center may control the phone from an application running on a server or desktop.

Voice Over Internet Protocol (VoIP) takes the analog signal from a traditional phone and converts it into digital data for transmission over the Internet. One system uses an Analog Telephone Adapter (ATA). The ATA receives a traditional phone signal from a traditional RJ-11 phone jack and coverts the signal into Internet protocol. A second system utilizes a specialized Internet protocol (IP) phone. The (IP) phone looks just like a traditional phone with a handset, cradle and buttons. But instead of having the standard RJ-11 phone connectors, IP phones have an RJ-45 Ethernet connector. IP phones connect directly to the router and have all the hardware and software necessary to handle the IP call. A third system utilizes the sound card of a personal computer to receive and transmit the analog signal. The personal computer processes the analog signal into VoIP and transmits the VoIP over the local network.

However, the above VoIP system when used in a contact center may heavily rely on the personal computer of an agent. The VoIP may burden the personal computer with additional processing resources, add latency and may adversely affect the VoIP traffic. Using IP phones may create the need for additional or duplicate equipment, for example, a keypad, which adds to the cost of the system and may create additional errors within the system. For example, an agent may accidentally press the keypad, which may cause a misdial while the contact center hardware is attempting to dial a number for the IP phone. In addition, when using an ATA-type system, the two wire analog phones may inject echoes into the system requiring additional processing by the system. Accordingly, there is a need for a cost efficient system for a contact center that allows the agent to easily place and receive calls using the hardware and software of the contact center.

### SUMMARY

Accordingly, the present invention is a novel system and device that converts between Voice Over Internet Protocol (VoIP) network of a contact center and an audio signal received and generated by an agent of the contact center wearing the headset. The exemplary method may include a VoIP terminal, an audio terminal, and a processor. The VoIP terminal may receive and transmit VoIP instructions and application program interface instructions over a contact center network. The audio terminal may receive an audio signal from a microphone and transmit an audio signal to a speaker. The processor may convert a received VoIP signal to the transmitted audio signal broadcasted by the speakers and convert the received audio signal from the microphone to transmitted VoIP instructions.

Embodiments of the invention may have one or more of the following features. The availability status of the agent associated with the VoIP terminal may be determined by a connection to the audio terminal. In another embodiment, the audio terminal may have a separate microphone and speaker signals, typically referred to in telephony as “4wire audio”. The 4wire audio may be either two pairs of wires or with two signal wires and a common ground, depending on the connector. Stereo audio to the headset is yet another embodiment. In another embodiment, a wireless connection to a headset may be used with a wireless transceiver. The gain of the audio signal or other signal processing may be controlled by an application program interface. In yet another embodiment, the user interface device may have a connection indicator or an availability switch. The availability switch may determine the availability status of the agent associated with the VoIP terminal.

Embodiments of the invention may have one or more of the following features. Some embodiments may have a separate network or dedicated processor from the personal computer of the agent. These embodiments may reduce costs, space, and accidental misuse of headphone handset, buttons, and display by call center agents. Embodiments may provide software controls to mix audio with the VoIP call audio for various other purposes of the call center. Embodiments may allow for use as an emergency phone even when the personal computer of the agent is unavailable. Further aspects, features, and advantages will become apparent in view of the detailed description, drawings and claims.

### BRIEF DESCRIPTION OF THE DRAWINGS

These and other features and advantages of the present invention will be better understood by reading the following detailed description, taken together with the drawings wherein:

FIG. 1A is a block diagram of a system implementing a VoIP adapter system within a contact center, according to an exemplary embodiment of the present invention;

FIG. 1B is a block diagram of a VoIP adapter, according to an exemplary embodiment of the present invention;

FIG. 2 is a functional block diagram of a wireless VoIP headset, according to an exemplary embodiment of the present invention.

FIG. 3 is a functional block diagram of a wireless VoIP headset, according to a second exemplary embodiment of the present invention.

### DETAILED DESCRIPTION

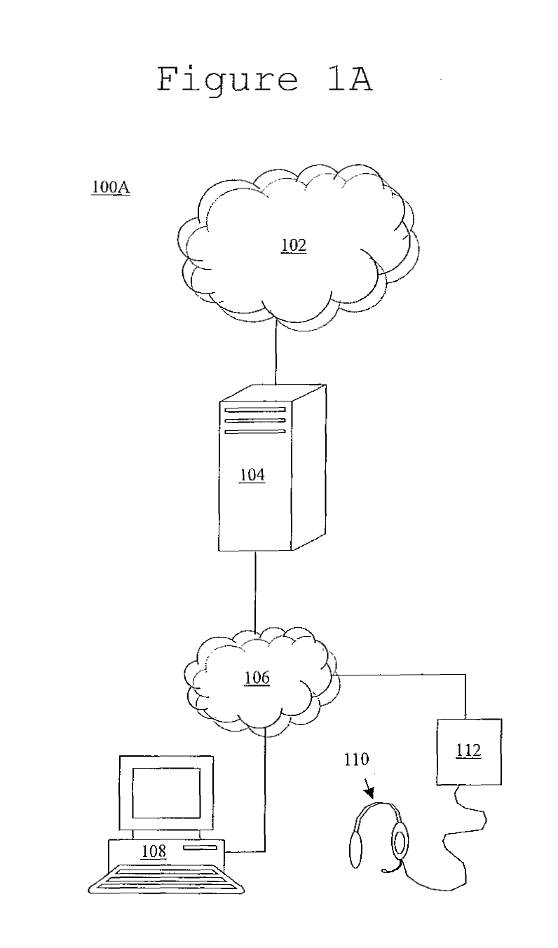

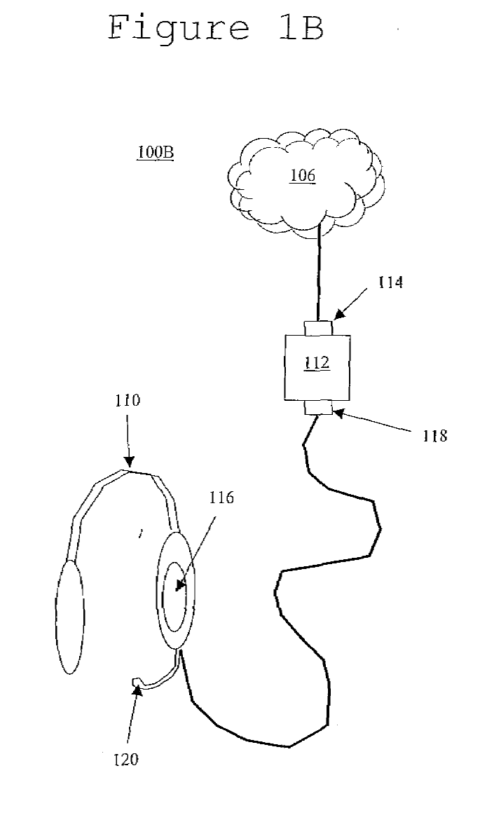

The VoIP adapter of the present invention provides a cost effective device and system for providing VoIP to agents of a contact center. Referring to FIG. 1A, an exemplary embodiment of the system 100A receives and transmits calls from the contact center via a wide area network 102. The wide area network 102 may connect to other local networks and public branch exchanges (PBX). A server 104 receives and transmits the VoIP calls to and from the wide area network 102. The server 104 directs the calls to the proper agent to handle the call. The agents of the call center access the calls from a local area network 106 of the contact center. The agent may have a desktop 108 and a headset 110 to assist the agent in handling the calls. It should be understood that the system 100, shown in FIG. 1A, is for illustrative purposes. Additional network components, for example, routers, gateways and servers, may be used to implement the system.

The agent converses with the customer via the headset, which has a microphone 120 and one or more speakers 116. During an outgoing campaign the server 106 or the desktop 108 may place a call to a customer as directed by contact center software running on a server or desktop. For example, the contact center may have a list of customers to contact. The server may attempt to dial each customer. Some customers may not be available or may request a call back at a later time. Once an available customer is identified, the customer is transferred to an available agent. All of this may be performed via an automated process outside the agent's control.

An available agent is selected and the call to the customer is connected to the agent. The microphone 120 receives the voice of the agent. The microphone 120 generates an audio signal. The audio signal is sent to a VoIP adapter 112 that coverts the audio signal into VoIP signal. The VoIP signal may be a variety of protocols, for example, Real-Time Transport Protocol (RTP) media with Session Initiation Protocol (SIP), H323, MGCP, or a proprietary protocol. The VoIP signal is sent over the local area network 106 and routed to the customer via the wide area network 102. Similarly, the voice of the customer is received from the wide area network 102 and transmitted to the VoIP adapter 112 via the local area network 106. The VoIP adapter converts the VoIP signal into an audio signal that produces sound generated by the speakers 116 of the agent's headset 110. The VoIP adapter 112 may have a Media Access Controller (MAC) address or other type of address that allows the network components to identify the endpoint and send/receive communications to the endpoint, as an individual skilled in the art of networks would appreciate.

The VoIP adapter 112 may use standard Dynamic Host Configuration Protocol (DHCP) to get an IP address and call center server information in order to get configuration details, associated to the MAC address. Once the IP address is sent, a control program (or web browser) can connect to the device via the VoIP terminal, and allow manual individual phone configuration. In an example when no DHCP is detected VoIP adapter 112 may revert to a manufactured default static IP address. In another example, a static IP address can be configured from the audio terminal, for example, by tapping on the headset mute button, or the VoIP adapter 112 may use minimal automatic speech recognition to allow the agent to enter the static IP address, which is spoken, by the agent into the microphone.

Since the headset 110 and VoIP adapter 112 has a minimal user interface, the agent is less likely to accidentally press a button that may generate an error or cause disconnect with the customer. The local area network 106 may be a separate, dedicated network for handling VoIP or may be a network that combines other data communications. In the example shown in FIG. 1A, the local area network 106 also handles other data communications.

The VoIP adapter 112 may have a memory and dedicated processor for carrying out features of the invention described later herein. The memory and dedicated processor may be limited to the speed and capacity required for specific functions of the VoIP adapter 112. According to exemplary systems, applications running on the agent's desktop 108 or the server 104 may also access the processing device of the VoIP adapter 112. Applications may be carried out on the dedicated processor of the VoIP adapter 112, by an external server 104 or desktop 108, or a combination of both.

For example, audio signal gain or other device controls may be controlled by an application running on the agent's desktop. For example, the agent may click on a soft-button of an application running on the agent's desktop. The desktop 108 via an application program interface may transmit instructions over the local area network 106 to the VoIP adapter 112. A processor of the VoIP adapter 112 may execute the instruction and cause a change in the audio gain. The system may use this method to perform other functions as well, for example but not limited to, conference calling, transferring calls, hold, mute, connect/disconnect, sidetone gain, and sending touchtones. The gain of the audio signal in either direction, as well as other signal processing may be controlled by the application program interface. This may provide benefits compared to manual amplifier or phone volume controls as the call center software can remotely change the levels if the signal is too low, or can be reset to defaults on reset.

In another example, the agent's availability may be determined by a connection to or switch of the VoIP adapter 112. When the headset is plugged into the VoIP adapter 112 or to terminal 118 or connected via in-line quick-release in cable to headset or if wireless connection is established, the connection can be automatically sensed and, the VoIP adapter 112 may send a signal to applications of the server 104 or agent's desktop 108 notifying the application that the agent is now available to receive calls. The VoIP adapter 112 may use the load of the headset 110 or other techniques to determine that the headset 110 has been plugged into the VoIP adapter 112. In this example an agent may inform applications of a break or the end of a work session by unplugging the headset. In another example, the loss of wireless headset connection may also be sensed to determine that the agent associated with the headset 110 is no longer available. The application of the contact center may remove the agent from a list of available agents handling calls. Additional features may be incorporated to prevent the agent from accidentally unplugging the headset and causing the system to improperly assume the agent is taking a break. For example, the agent may be prompted on the desktop 108 to verify that the agent is taking a break or to enter when the agent plans to resume handling calls.

Referring to FIG. 1B, VoIP adapter 112 and headset 110 is shown in more detail 100B. Internet protocol signals in the form of Internet protocol (IP) packets are sent and received from the local area network 106 by a VoIP terminal 114. The VoIP terminal 114 may receive VoIP packets such as RTP media and SIP call control, as well as IP packets, containing instructions from a program application interface as previously discussed. The VoIP adapter 112 is not limited to receiving data over the VoIP terminal 114. The VoIP adapter 112 may also have an additional terminal for receiving instructions from applications of the contact center. For example, the VoIP terminal 114 may he connected to a network that transmits VoIP packets. Another terminal (not shown) may be used to connect to a network that handles hardware instructions of the network. Both systems of transmitting and receiving IP packets and instructions are within the scope of the invention.

The VoIP terminal 114 may be two or more RJ45 connectors interconnected by an internal LAN hub or switch, to allow sharing a single LAN data drop with the device and a PC or other data or VoIP device The VoIP terminal 114 may also be a wireless transceiver (no connector) for a standard such as WiFi®. This may avoid requiring any LAN connectors for the device, and may provide the VoIP data on a separate subnet from data subnet connected to the PC.

The VoIP adapter 112 converts the VoIP packets into audio signals that are transmitted to the speakers 116 via the audio terminal 118. The audio signal may be an analog signal that is directly used by the speaker 116. The VoIP adapter 112 may have an amplifier that produces the desired volume and broadcasts the audio signal over the speaker 116 of the headset 110. In another example, the VoIP adapter 112 may send a digital signal that is used by an amplifier in the headset 110 to produce the audio signal used by the speaker 116.

The audio terminal 118 may also receive an analog signal of a microphone 120 of the headset 110. The VoIP adapter 112 may process the analog signal by providing the desired gain and sampling the signal to produce the VoIP packets that are transmitted to a device of the customer. The analog audio signals may be transmitted over a four-wire/channel system 124. Two wires may be associated with the microphone and a microphone ground and two wires may be associated with the speaker and speaker ground. This type of system may be used to prevent echoes produced by the audio components. The four-wire system allows the VoIP adapter 112 to receive a purer audio signal without echoes and reduces the need for components to process and filter the received audio signal.

The audio terminal 118 may be one or more standard 3.5 mm stereo jacks as used on PC and other audio equipment to connect each of a headset and/or a microphone. The audio terminal 118 may also be a 2.5 mm headset jack as used with cellular or cordless phones. The audio terminal 118 may also be a wireless transceiver (with no connector), using a standard such as Bluetooth®, supporting cordless headsets or earpieces with microphone. The audio terminal may also be a RJ22 or RJ9 standard headset connector or a combination of the above, allowing the agent to use different types of headsets. The audio terminal 118 may be any multiple of the above, allow two or more nearby agents to use the single VoIP adapter 112 for audio. According to this example, the VoIP adapter 112 may handle multiple lines of communication.

The present invention is not limited to separate VoIP adapter 112 and headset 110. The components may be combined into a single piece of equipment. The components of the VoIP adapter 112 may he housed within the headset 110 with a network plug extending from the headset 110 for connecting to the local area network 106. For example, the network plug may be an Ethernet RJ45 plug that the agent plugs into a port on the local area network 106. When the local area network 106 of the contact center detects the connection and new device on the network, the network 106 may associate the headset/VoIP adapter with a specific agent and proceed to connect customer calls to the headset/VoIP adapter.

The invention allows the VoIP adapter 112 to be much smaller and reduces the power consumption of the VoIP adapter 112. The VoIP adapter 112 and headset 110 may receive power over the Ethernet connection or may have an independent source of power, for example, a battery housed within the headset 110 of the VoIP adapter 112 may provide power. In another example the VoIP adapter 112 may have a utility plug that plugs into a wall socket to receive power.

The agent's desktop 108 may use a sound driver that utilize VoIP RTP to stream audio to the agent over the LAN 106 to the VoIP adapter 112 instead of a physical sound card. The RTP may be configured to be sent and received to the agents VoIP adapter 112. The VoIP adapter 112 may provide the sound to the audio terminal and headset 110. The RTP can be high fidelity for music as the LAN 106 between the desktop 108 and the VoIP adapter 112 may be high bandwidth. This feature allows using the VoIP adapter 112 instead of desktop 108 soundcard or directly connected sound device such as USB or firewire. This feature also allows for a desktop running in a terminal server environment where the software is running remotely.

The VoIP adapter 112 may also include software controls to mix the audio with the VoIP call audio as needed by the call center. This allows playing back a sound file on the desktop 108 or server 104 to both agent and caller. This also allows playing audio, mixed with caller, just to agent, for example, alerts to be heard by the agent while on a call. This also allows combining an application on the agent's desktop 108, for example, an application that would mute agent's music sources (CD, MP3 player) while on a call. Other software controls may allow the recording of the agent and caller. This may be accomplished as two channels (stereo) with agent on one channel and caller on the other. A desktop audio out connector may be used to connect the desktop 108 audio output into the VoIP adapter 112 or a desktop audio in connector may be used to connect the VoIP adapter 112 output into the desktop 108 audio input for the similar functionality as previously described.

Additional software in the VoIP adapter 112 can allow for use as emergency phone even when the desktop 108 is not available. For instance if no control application has control of the VoIP adapter 112, the VoIP adapter 112 may auto-answer incoming calls. The agent may be able to force a hang up of the call by disconnecting the headset, used to indicate availability when under normal control. In addition, headset reconnect, possibly done two times in a row, can be used to force an emergency outgoing call. The VoIP adapter's 112 processor may also include ASR (automated speech recognition) to allow entering a number, or may offer a list of preprogrammed emergency numbers to call, for example, home number, office security center, or 911.

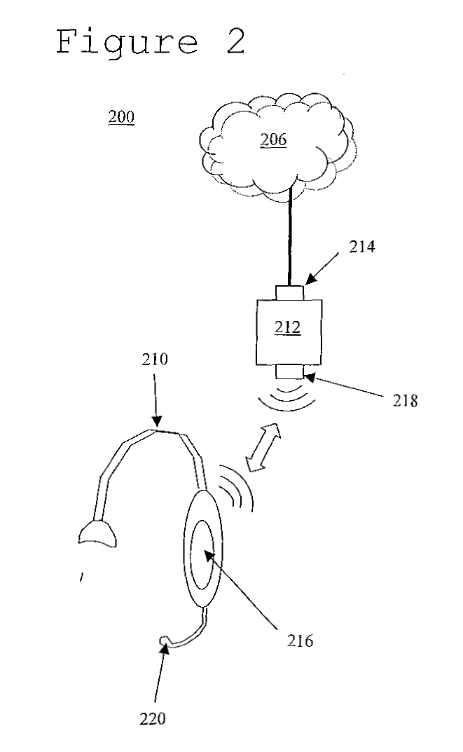

Referring to FIG. 2, another embodiment 200 of the invention may use a wireless channel to communicate with the headset 210. The VoIP signal is transmitted over the local area network 206 of the contact center. The VoIP adapter 212 receives the VoIP signal via the VoIP terminal 214 and converts the signal into an audio signal. The audio signal is broadcast by a wireless transceiver 218 to a wireless transceiver located in the headset 210. The broadcast audio signal may utilize a variety of wireless protocols, for example, Bluetooth®. The processor in the headset 210 may convert the digital audio signal into an analog audio signal that is played over the speakers 216 of the headset.

Similarly, the headset may receive an audio signal from a microphone 220 of the headset. The processor of the headset may convert the audio signal to a digital signal that is transmitted wirelessly back to the VoIP adapter 212 via the wireless transceiver 218. The VoIP adapter 212 converts the audio signal into a VoIP signal and sends it to the customer. The system is not limited to the setup discussed above. In another example, the local area network 206 of the contact center may be wireless. The VoIP signal may be transmitted wirelessly to the headset 210 which may house a wireless transceiver that receives the signal. The VoIP adapter may also he housed within the headset 210 and convert between VoIP signals and audio signals.

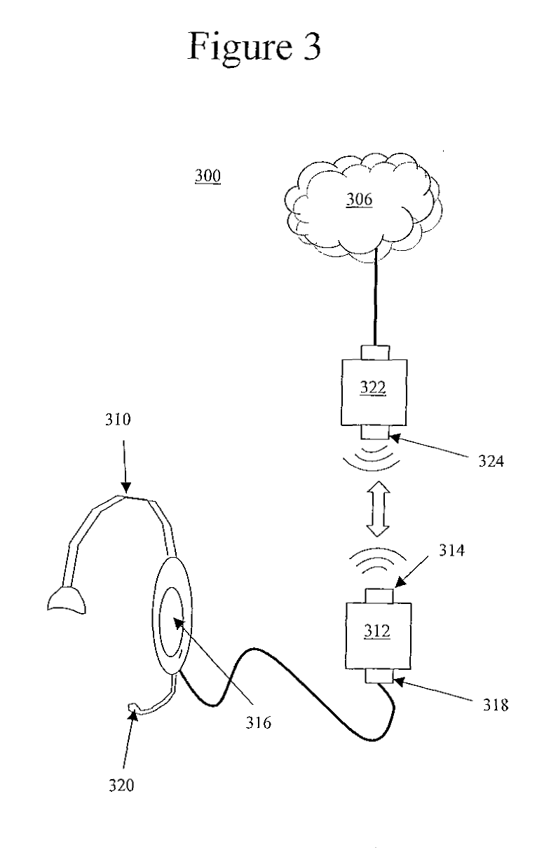

Referring to FIG. 3, another embodiment 300 of the invention may use a wireless channel to communicate with the VoIP adapter 312. The VoIP or audio signal is transmitted over the local area network 306 of the contact center via a wireless protocol. A wireless router 322 or other similar device receives and transmits wireless signals from the local area network 306 to the VoIP adapter 312. The wireless protocol may be, for example, a private, dedicated network used only for the VoIP adapters 312 of the call center. A transceiver 324 broadcasts the wireless signal to headsets 310 located within range. The VoIP adapter 312 receives the signal via the wireless terminal 314 and converts the signal into an audio signal. A wired connection to the headset 310 then carries the audio signal to the speaker 316 and microphone 320 of the headset 310.

Similarly, the VoIP adapter 312 may receive an audio signal from a microphone 320 of the headset. The processor of the VoIP adapter 312 may convert the audio signal to a digital signal that is transmitted back to the wireless router 322 via the wireless transceiver 314. The system is for illustrative purposes and is not limited to the setup or features discussed above. In another example, the VoIP adapter 312 may be clipped to the belt of the agent wearing the headset 310. The VoIP adapter 312 may house rechargeable batteries or other portable power source to supply power required by the VoIP adapter 312. Modifications and substitutions by one of ordinary skill in the art are considered to be within the scope of the present invention, which is not to be limited except by the following claims.

1-7. (canceled)

8. A headset that converts between the Voice Over Internet Protocol (VoIP) network of a contact center and an audio signal received and generated by an agent of the contact center wearing the headset comprising:
a VoIP terminal for receiving and transmitting VoIP instructions and application program interface instructions over a contact center network;
an audio terminal for receiving an audio signal from a microphone and transmitting an audio signal to a speaker; and
a processor for converting a received VoIP signal to the transmitted audio signal and converting the received audio signal to a transmitted VoIP instruction.

9. The headset of claim 8, wherein availability status of the agent associated with the VoIP terminal is determined by a connection to the audio terminal.

10. The headset of claim 8, wherein the audio terminal is a separate microphone and speaker signal connection.

11. The headset of claim 8, wherein the audio terminal is a wireless connection to a headset having a wireless transceiver, an amplifier, a speaker, and a microphone.

12. The headset of claim 8, further comprising a user interface consisting essentially of a connection indicator.

13. The headset of claim 8, wherein the gain of the audio signal is controlled by an application program interface.

14. The headset of claim 8, further comprising an availability switch wherein availability status of the agent associated with the VoIP terminal is determined by the switch.

15-19. (canceled)

20. The headset of claim 8, further consisting essentially of an availability switch wherein availability status of the agent associated with the VoIP terminal is determined by the switch.
